(19) United States
(12) Patent Application Publication
(10) Pub. No.: US 2013/0193599 A1
(43) Pub. Date: Aug. 1, 2013

(54) DUAL ACTION GYRATORY THERMOFORMING PRESS

(71) Applicant: Roman Wrosz, Poway, CA (US)

(72) Inventor: Roman Wrosz, Poway, CA (US)

(73) Assignee: Roman's Design, Ramona, CA (US)

(21) Appl. No.: 13/360,392

(22) Filed: Jan. 27, 2012

(51) Int. Cl. A61C 13/20

(52) U.S. Cl. 264/16; 425/357; 264/320

(57) ABSTRACT

Embodiments provide a dual action gyratory thermoforming press. The dual action gyratory thermoforming press can include a multiposition gyratory head. The multiposition gyratory head can include multiple forming vessels that can include a mold platform. The multiposition gyratory head can also be connected to a bottom platform. The dual action gyratory thermoforming press can be brought into configuration for forming by rotating the multiposition gyratory head such that a forming vessel is in a forming position, displacing the bottom platform to bring the multiposition gyratory head into a forming position, and displacing the mold platform into a forming position.

### BACKGROUND OF THE INVENTION

1. Field of the Invention

The technology relates to the field of thermoforming.

2. Description of the Related Art

Thermoforming is a manufacturing process where a material, such as a plastic sheet is heated to a pliable forming temperature and formed into a specific shape.

### SUMMARY OF THE INVENTION

Some embodiments relate to a dual action gyratory thermoforming press. In some embodiments, the dual action gyratory thermoforming press can have a top platform, a bottom platform that is displaceable from a first position relatively distant from the top platform to a second position relatively proximate to the top platform, and/or a multiposition gyratory head that is rotationally connected to the bottom platform. In some embodiments, the multiposition gyratory head can have, for example, at least a first forming vessel that includes a first mold platform, and a second forming vessel. The dual action gyratory thermoforming press can further include a cam that interacts with the first mold platform to displace the first mold platform relative to the top platform.

In some embodiments, the second forming vessel of the dual action gyratory thermoforming press can have a second mold platform that can, in some embodiments, interact with the cam to displace the second mold platform relative to the top platform.

In some embodiments of the dual action gyratory thermoforming press, the multiposition gyratory head can include a third forming vessel, a fourth forming vessel, and a fifth forming vessel. In some aspects, the third forming vessel, the fourth forming vessel, and the fifth forming vessel respectively include a third mold platform, a fourth mold platform, and a fifth mold platform. The cam of the dual action gyratory thermoforming press can, for example, interact with the third mold platform, the fourth mold platform and the fifth mold platform to displace the third mold platform, the fourth mold platform and the fifth mold platform relative to the top platform.

In some embodiments, the dual action gyratory thermoforming press can include a drive connected to the multiposition gyratory head. The drive can, for example, rotate the multiposition gyratory head.

Some embodiments relate to a method of thermoforming an item. The method can include, for example, placing a mold in a forming vessel of a multiposition gyratory head, rotating the forming vessel of the multiposition gyratory head into alignment with mating features of a top platform, displacing the gyratory head towards the top platform, and rotating the forming vessel of the multiposition gyratory head out of alignment with mating features of the top platform.

In some embodiments, the method of thermoforming an item can further include, aligning a sheet with the mating features of the top platform and/or placing the mold on a mold platform in the forming vessel. In some embodiments of the method of thermoforming an item, the mold platform is displaced towards the mating features of the top platform. In some embodiments of the method of thermoforming an item, for example, the forming vessel of the multiposition gyratory head mates with the mating features of the top platform when the multiposition gyratory head is displaced towards the top platform. In some embodiments of the method of thermoforming an item, the top platform is displaced towards the gyratory head, the mold is removed from the forming vessel, and/or the item, which can include, for example, an orthodontic insert, is separated from the mold.

Some embodiments relate to a method of forming an orthodontic insert. The method of forming an orthodontic insert includes, for example, preparing mold corresponding to a tooth of a patient, placing the mold in a forming vessel of a multiposition gyratory head, rotating the forming vessel of the multiposition gyratory head into alignment with mating features of a top platform, displacing the gyratory head towards the top platform, forming the orthodontic insert on the mold, rotating the forming vessel of the multiposition gyratory head out of alignment with mating features of the top platform, and/or separating the mold and the formed orthodontic insert.

In some embodiments, the method of forming an orthodontic insert can include placing a second mold in a second forming vessel of a multiposition gyratory head, rotating the second forming vessel of the multiposition gyratory head into alignment with mating features of the top platform, and/or forming a second orthodontic insert on the second mold.

The foregoing is a summary and thus contains, by necessity, simplifications, generalization, and omissions of detail; consequently, those skilled in the art will appreciate that the summary is illustrative only and is not intended to be in any way limiting. Other aspects, features, and advantages of the devices and/or processes and/or other subject matter described herein will become apparent in the teachings set forth herein. The summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

FIG. 1 depicts a schematic illustration of one embodiment of a dual action gyratory thermoforming press.

FIG. 2 is a flow chart illustrating one method of using a dual action gyratory thermoforming press.

### DETAILED DESCRIPTION OF THE PREFERRED EMBODIMENT

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

Some embodiments disclosed herein relate generally to a dual action gyratory thermoforming press. In some embodiments, the dual action gyratory thermoforming press can be configured for use in thermoforming of items. In some embodiments, the dual action gyratory thermoforming press can include, for example, a pressing chamber and a gyratory head that can include a mold platform. In some embodiments, the dual action gyratory thermoforming press can be configured to thermoform an item by, among other things, displacing the gyratory head, and the connected mold platform, towards the pressing chamber and separately displacing the mold platform towards the pressing chamber. In some embodiments, the dual action gyratory thermoforming press can facilitate the rapid forming of a plurality of items that are each formed with a unique mold. However, a person skilled in the art, having the instant specification, will appreciate that the dual action gyratory thermoforming press and other subjects disclosed herein can comprise a variety of features and be used in diverse ways.

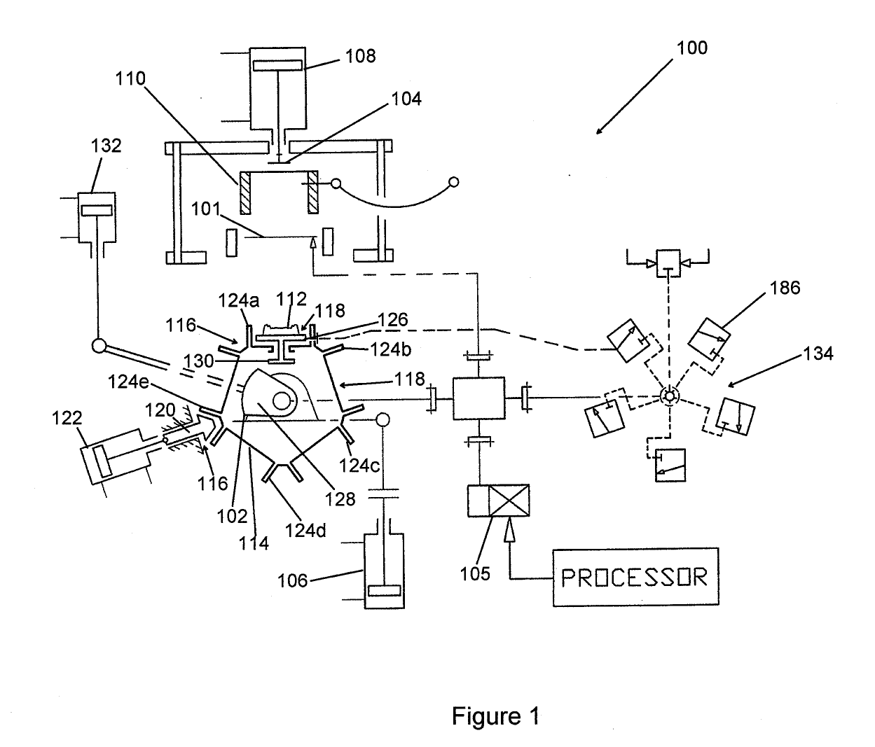

FIG. 1 depicts a schematic illustration of one embodiment of a dual action gyratory thermoforming press 100 configured for thermoforming sheet 101. In some embodiments, the sheet 101 can comprise a variety of materials. In some embodiments, for example, the sheet 101 can comprise a manmade material, such as, for example, a plastic, a polymer, or any other desired thermoformable material.

The sheet 101 can comprise a variety of shapes, sizes, and thicknesses. In some embodiments, for example, the sheet 101 can be sized for forming of a specific desired item, whereas in other embodiments, for example, the sheet 101 can be larger than necessary for forming a desired item. In one embodiment, a sheet have a thickness of, for example, 1/32 inch, 1/16 inch, ⅛ inch, ¼ inch, or any other desired thickness.

The sheet 101 can be stored in a variety of different ways. In some embodiments, a plurality of sheets can be stacked. In some embodiments, for example, the sheet 101 can be rolled into a roll, and a portion or all of sheet 101 can be used to form a single item. In some embodiments in which the sheet 101 is on a roll, the dual action gyratory thermoforming press 100 can further comprise features to automatically feed the desired amount of sheet 101 for the forming of each item into the forming areas of the dual action gyratory thermoforming press 100. In some embodiments, these features can comprise a robotic system configured to automatically feed the sheet 101 into the dual action gyratory thermoforming press 100. In some embodiments, the sheet 101 can be manually fed into the dual action gyratory thermoforming press 100. Advantageously, the combination of a roll of sheet 101 and features configured to automatically feed the sheet 101 into the dual action gyratory thermoforming press 100 can facilitate faster processing times and thereby decrease manufacturing costs and increase manufacturing output.

The dual action gyratory thermoforming press 100 depicted in FIG. 1 includes a bottom platform 102 and a top platform 104. The bottom platform 102 and the top platform 104 combine with other components of the dual action gyratory thermoforming press 100 and interact with each other to define an area in which an item is formed.

In some embodiments, the bottom platform 102 and the top platform 104 of the dual action gyratory thermoforming press 100 are displaceable relative to each other. Thus, the bottom platform 102 can be moved from a first position to a second position. In some embodiments, the second position of the bottom platform 102 can be closer to, or farther from the top platform 104. Similarly, the top platform 104 can be likewise positioned relative to the bottom platform 102 by moving the top platform 104 from a first position to a second position.

In some embodiments, the bottom platform 102 and the top platform 104 can be relatively displaced via a variety of features or systems, including, for example, a motor, and engine, a drive, a mechanical system, an electro-mechanical system, a hydraulic system, a pneumatic system, or any other desired feature or combination of features. As depicted in FIG. 1, the bottom platform 102 is displaceable via hydraulic piston 106 and the top platform 104 is displaceable via hydraulic piston 108. In some embodiments, the hydraulic pistons 106, 108 can be components of a hydraulic system which can include, for example, a hydraulic pump, one or several valves, hydraulic fluid lines, one or several sensing features, electronic controls, a programmable processor, or any other desired feature. FIG. 1 depicts one embodiment comprising a programmable processor 105. The programmable processor 105 can comprise a processor and memory. In some embodiments, the memory can comprise stored instruction corresponding to the desired operation of components connected with the programmable processor 105. The programmable processor 105 can receive inputs from components of the dual action gyratory thermoforming press 100, such as, for example, from a sensing feature, and can control the operation of one or several components of the dual action gyratory thermoforming press 100. In some embodiments, the control of the dual action gyratory thermoforming press 100 can be at least partially based on inputs received by the programmable processor 105.

In some embodiments, the programmable processor 105 can be configured to control the positioning and movement of the bottom platform 102 and the top platform 104 by controlling individual components of the hydraulic system. The programmable processor can, for example, coordinate the function of components of the hydraulic system, such as, for example, the hydraulic pump and/or the one or several valves, to move the bottom platform 102 and the top platform 104 between a first position and a second position in which the desired item is formed.

As depicted in FIG. 1, the top platform 104 connects with a pressing vessel 110. The pressing vessel 110 can be sized and configured to define a portion of the forming area of the dual action gyratory thermoforming press 100 in which an item is formed. Specifically, the pressing vessel 110 can be sized and configured to define a portion of the forming area of the dual action gyratory thermoforming press 100 of sufficient size to allow forming of the item.

As the pressing vessel 110 defines a portion of the forming area of the dual action gyratory thermoforming press 100, the remainder of the forming area of the dual action gyratory thermoforming press 100 is defined by other components of the dual action gyratory thermoforming press 100. To facilitate the complete definition of the forming area of the dual action gyratory thermoforming press 100, the pressing vessel 110 can comprise features configured for interaction with features of other components of the dual action gyratory thermoforming press 100 that are discussed at greater length below. In some embodiments, for example, the pressing vessel 110 can comprise one or several surfaces configured to mate with mating surfaces of other components of the dual action gyratory thermoforming press 100. In some embodiments, these surfaces of the pressing vessel 110 can be configured to sealingly mate with the mating surfaces of other components of the dual action gyratory thermoforming press 100, and can include features configured to facilitate the sealing and/or mating interaction with the mating surfaces of other components of the dual action gyratory thermoforming press 100. In some embodiments, these features can include, for example, a gasket, a latch, a clamp, an o-ring, a seal, a mechanical retention device, an electrical retention device, or any other desired feature.

In some embodiments, the pressing vessel 110 can be fluidly connected to a pressure regulating system. In some embodiments, the pressing vessel 110 can comprise an opening connected with an air pressure regulating system. In some embodiments, the pressure regulating system can be configured to selectively increase and/or decrease the pressure within the portion of the forming area defined by the pressing vessel 110. In some embodiments, the pressure regulating system can include, for example, a pump, such as, a vacuum pump, one or several valves, pressure lines, one or several sensing features, electronic controls, a programmable processor, or any other desired feature. In some embodiments, the programmable processor 105 can control components of the pressure regulating system to cause pressure variations within the pressing vessel 110.

As depicted in FIG. 1, the bottom platform 102 connects to a multiposition gyratory head 114. The multiposition gyratory head 114 can include an axis of rotation. In some embodiments, the multiposition gyratory head 114 can be connected to a feature configured to rotate the multiposition gyratory head 114 about the axis of rotation. This feature can comprise, for example, an actuator, a motor, an engine, a mechanical system, a hydraulic system, a pneumatic system, an electro-mechanical system, or any other desired feature or combination of features. In some embodiments, the rotation feature can be configured to rotate the multiposition gyratory head 114 about the axis of rotation and between a plurality of predetermined positions. A person of skill in the art will recognize that a multiposition gyratory head 114 can be rotated to any of a desired number of predetermined positions, and that the present disclosure is not limited to a specific number of predetermined positions.

In some embodiments, the predetermined positions of rotation of the multiposition gyratory head 114 can correspond to the predetermined positions on the multiposition gyratory head 114. In some embodiments, the multiposition gyratory head 114 comprises a plurality of different positions, including, for example, a locking position 116 and a forming position 118. The locking position 116 can comprise a variety of shapes and sizes, and can be configured for interaction with a locking feature 120 to lock the multiposition gyratory head 114 in a desired position. In some embodiments the locking feature 120 can be connected to a feature configured to move the locking feature 120 between a first position in which the locking feature 120 securingly interacts with the locking position 116 of the multiposition gyratory head 114 and a second position in which the locking feature is retracted from interaction with the locking position 116 of the multiposition gyratory head 114. As depicted in FIG. 1, this feature configured to move the locking feature 120 can comprise a hydraulic piston 122.

As discussed above with regards to hydraulic pistons 106, 108, the hydraulic piston 122 can be a component of a hydraulic system. In one non-limiting embodiment, the hydraulic system can comprise, for example, a hydraulic pump, one or several valves, hydraulic fluid lines, one or several sensing features, electronic controls, or a programmable processor. In some embodiments, hydraulic piston 122 can comprise a component of the hydraulic system including hydraulic pistons 106, 108. As also discussed above, the programmable processor 105 can be configured to control the positioning and movement of the hydraulic piston 122, and thereby of the locking feature 120 by controlling individual components of the hydraulic system.

The forming position 118 of the multiposition gyratory head 114 can comprise a forming vessel 124 having any of a variety of shapes and sizes. In some embodiments, the multiposition gyratory head 114 can comprise a plurality of forming vessels 124. FIG. 1 depicts one embodiment of a multiposition gyratory head 114 comprising a first forming vessel 124a, a second forming vessel 124b, a third forming vessel 124c, a fourth forming vessel 124d, and a fifth forming vessel 124e. In some embodiments, the forming vessel 124 is configured to define a portion of the forming area of the dual action gyratory thermoforming press 100. In some embodiments, for example, the forming vessel 124 can comprise features configured to interact with features of the pressing vessel 110. In some embodiments, mating surfaces of the forming vessel 124 can matingly interact with surfaces of the pressing vessel 110. In some other embodiments, the mating surfaces of the forming vessel 124 can sealingly mate with surfaces of the pressing vessel 110. The forming vessel 124 can, in some embodiments, include features configured to facilitate the sealing and/or mating interaction with the mating surfaces of other components of the dual action gyratory thermoforming press 100. These features can include, for example, a gasket, a latch, a clamp, an o-ring, a seal, a mechanical retention device, an electrical retention device, or any other desired feature.

In some embodiments, the forming vessel 124 can be fluidly connected to a pressure regulating system. In some embodiments, the forming vessel 124 can comprise an opening connected with an air pressure regulating system. In some embodiments, the pressure regulating system can be configured to selectively increase and/or decrease the pressure within the portion of the forming area defined by the forming vessel 124. In some embodiments, the pressure regulating system can include, for example, a pump, such as, a vacuum pump, one or several valves, pressure lines, one or several sensing features, electronic controls, a programmable processor, or any other desired feature. In some embodiments, the programmable processor 105 can control components of the pressure regulating system to cause pressure variations within the forming vessel 124.

In some embodiments, the multiposition gyratory head 114 can further comprise a mold platform 126. As depicted in FIG. 1, the mold platform 126 is positioned within the portion of the forming area defined by the forming vessel 124. The mold platform 126 can comprise a variety of shapes and sizes and can be made from a variety of materials. The mold platform 126 can be configured to receive and hold a mold 112 during the forming process. In some embodiments, each forming vessel 124a, 124b, 124c, 124d, 124e contains a mold platform 126.

The mold 112 can have any desired shape and size, and can be made using any desired technique. In one embodiment, the mold 112 can have the shape of a body part, such as, for example, one or several teeth. In some embodiments, the shape of the mold 112 can match or replicate the shape of a specific patient's body part, such as one or more of the patient's teeth. In some embodiments, the shape of the mold 112 can correspond to an orthopedic component, a hearing aid, a prosthetic component, or any other desired component.

In some embodiments, the mold platform 126 is dynamically connected with the multiposition gyratory head 114. The dynamic connection of the mold platform 126 to the multiposition gyratory head 114 can advantageously allow the movement of the mold platform 126 between, for example, a first position and a second position. In some embodiments, the movement of the mold platform 126 between a first position and a second position enables positioning of the mold 112 on the mold platform 126 relatively closer to, or further removed from the pressing vessel. In some embodiments, the second position to which the mold platform 126 can be moved can be, for example, more closely located to the pressing vessel 110 than the first position. Advantageously, providing a multiposition gyratory head 114 with a moveable mold platform 126 can facilitate thermoforming by enabling control of the positioning of the mold platform 126 relative to the sheet 101. This independent control can facilitate the creation of formings with uniform thicknesses allowing by placement of the mold platform 126 in proximity to sheet 101, or at any desired position relative to the sheet 101, without contacting sheet 101.

The positioning of the mold platform 126 can be dynamically controlled via a movement feature. In some embodiments, this movement feature can comprise a single feature, or a system comprising a plurality of features. In some embodiments, the movement feature can comprise, for example, a mechanical system, a hydraulic system, a pneumatic system, an electro-mechanical system, or any other desired feature or combination of features. As depicted in FIG. 1, the movement feature can comprise a cam 128 configured for movement between a first position and a second position and for interaction with a following surface 130 of the mold platform 126. A person of skill in the art will recognize that the interaction between the cam 128 and the following surface 130 of the mold platform can result in the movement of the mold platform 126 from a first position to a second position. A person of skill in the art will further recognize that the cam 128 can have a wide range of profiles corresponding to a range of desired movements of the mold platform 126.

To control the movement of the mold platform 126, the cam 128 can be controllably connected to a motion controlling system. This system can include, for example, an actuator, a motor, an engine, a mechanical system, a hydraulic system, a pneumatic system, an electro-mechanical system, or any other desired feature or combination of features.

As depicted in FIG. 1, the cam 128 is connected to a hydraulic piston 132. The hydraulic piston 132 can be a component of a hydraulic system which can include, for example, a hydraulic pump, one or several valves, hydraulic fluid lines, one or several sensing features, electronic controls, a programmable processor, or any other desired feature. In some embodiments, hydraulic piston 132 can comprise a component of the hydraulic system including hydraulic pistons 106, 108, 122. As also discussed above, the programmable processor 105 can be configured to control the positioning and movement of the hydraulic piston 132, and thereby of the cam 128 by controlling individual components of the hydraulic system.

The dual action gyratory thermoforming press 100 can further comprise a valve system 134. The valve system 134 can comprise a plurality of valves 136. The valves 136 can control the pressurization of the portion of the forming area defined by the forming vessel 124. In some embodiments, a valve 136 can be associated with one or with several of the forming vessels 124.

In some embodiments, the dual action gyratory thermoforming press 100 comprises a drive 138. In some embodiments, the drive 138 can be controllably connected to the programmable processor 105. In some embodiments, the drive 138 can be connected to, for example, the multiposition gyratory head 114, the cam 128, and/or features configured for positioning the sheet 101 for forming. The drive 138 can comprise any desired mechanism or system, and can comprise, for example, a motor, an actuator, a hydraulic system, a pneumatic system, or any other desired system, mechanism, or feature.

The dual action gyratory thermoforming press 100 can be used in a variety of different ways to thermoform an item. In some embodiments, the dual action gyratory thermoforming press 100 can be used in production of a plurality of geometrically unique formed items. In some embodiments, these geometrically unique formed items can include, for example, orthodontic retainers, orthodontic aligners, orthopedic components, hearing aids, prosthetic components, insoles, orthotics, or any other geometrically unique formed item. Advantageously a multiposition gyratory head 114 comprising a plurality of forming vessels 124 can facilitate the rapid production of geometrically unique thermoformed items. Specifically, a multiposition gyratory head comprising a plurality of forming vessels 124 can simultaneously receive a mold 112 in one of its forming vessels 124, form an item using a mold 112 in another of its forming vessels 124, and have a mold 112 and item removed from yet another of its forming vessels 124. As these steps can be simultaneously performed, production rates can be increased and production disruptions can be decreased.

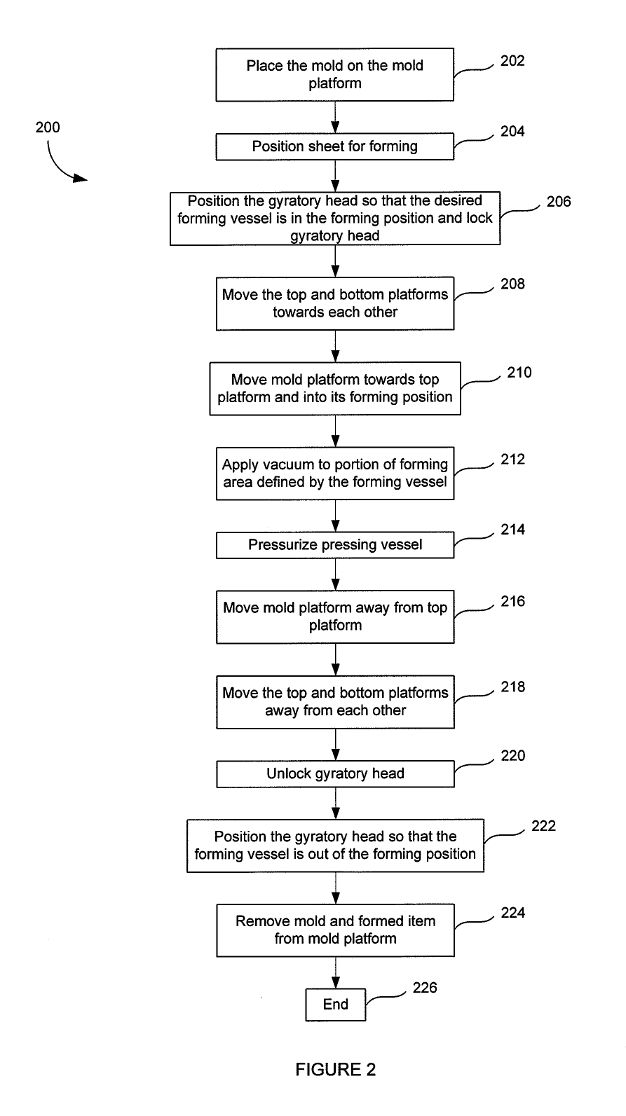

FIG. 2 depicts one embodiment of a process 200 for thermoforming an item with the dual action gyratory thermoforming press 100. Process 200 begins at block 202 and the mold 112 is placed on the mold platform 126. In some embodiments, the mold 112 can be manually placed on the mold platform 126, and in some embodiments, the mold 112 can be automatically placed on the mold platform 126. In one specific embodiment, a fill robot can automatically place the mold 112 onto the mold platform 126.

After the mold 112 is placed on the mold platform 126, the process 200 moves to block 204 and the sheet 101 is positioned for forming. As discussed above, the sheet 101 can be manually or automatically positioned for forming.

After the sheet 101 is positioned for forming, the process 200 moves to block 206 and the multiposition gyratory head 114 is moved so that the desired forming vessel is in position for forming an item and the multiposition gyratory head 114 is locked in that position. The multiposition gyratory head 114 can be moved into the desired position for forming in one embodiment, for example, by rotation of the multiposition gyratory head 114 about its axis of rotation. In some embodiments, a feature and/or system can be configured to controllably rotate the multiposition gyratory head 114 about its axis of rotation and to position the multiposition gyratory head 114 for forming of the item. In some embodiments, the multiposition gyratory head 114 can be moved and positioned such that the forming vessel 124 of the multiposition gyratory head 114 containing the mold 112 can interact with the pressing vessel 110 to form an item.

After the multiposition gyratory head 114 is positioned and locked in position, the process moves to block 208 and the bottom platform 102 and the top platform 104 are moved towards each other, from first positions to second positions. In some embodiments, the movement of the bottom platform 102 and the top platform 104 towards each other can culminate, for example, in the interaction of features of the bottom platform 102 with features of the top platform 104.

After the bottom platform 102 and the top platform 104 are moved into their second positions, the process 200 moves to block 210 and the mold platform 126 is moved towards the top platform 104 and into its position for forming. As discussed above, the molding platform 126 can moveably interact with a wide range of systems, features, or devices to achieve the displacement of the molding platform 126 from the first position to the second position.

After the molding platform 126 is in position for forming, the process moves to block 212 and a partial vacuum is applied to the portion of the forming area defined by the forming vessel 124. In some embodiments, the sheet defines a boundary between the portion of the forming area defined by the pressing vessel 110 and the portion of the forming area defined by the forming vessel 124. Advantageously, the application of a partial vacuum to the portion of the forming area defined by the pressing vessel 110 biases the sheet 101 towards the mold 112, and by controlling the strength of the partial vacuum, the relative positioning of the sheet 101 with respect to the mold 112 can be adjusted.

After a partial vacuum is applied to the region of the forming area defined by the forming vessel 124, the process 200 moves to block 214 and the pressing vessel, namely the portion of the forming area defined by the pressing vessel 106, is pressurized. In some embodiments the pressurizing of the pressing vessel 106 can be accompanied by the further application of a partial vacuum to the forming vessel 124. The pressurization of the pressing vessel 106, by itself, or in combination with the application of the partial vacuum to the forming vessel 124 forces the sheet 101 onto the mold 112 and thereby forms the item.

After the pressing vessel 106 is pressurized, and the item is formed, the process 200 moves to block 216 and the mold platform 126 is moved away from the top platform 104. The process then moves to block 218 and the bottom platform 102 and the top platform 104 are moved away from each other and from their second positions to their first positions. After the bottom platform 102 and the top platform 104 are moved away from each other, the process 200 moves to block 220 and the multiposition gyratory head 114 is unlocked.

After the multiposition gyratory head 114 is unlocked, the process 200 moves to block 222 and the multiposition gyratory head 114 is positioned so that the forming vessel 124 containing the used mold 112 is out of the position for forming. After the multiposition gyratory head 114 containing the used mold 112 is moved from the position for forming, the process moves to block 224 and the mold 112 and the formed item are removed from the mold platform 126. In some embodiments, the mold 112 and the formed item are manually removed from the mold platform 126, and in some embodiments, the mold 112 and the formed item are automatically removed from the mold platform 126. In some embodiments, the mold 112 and the formed item are simultaneously removed from the mold platform 126. In some embodiments, for example, the formed item is removed from the mold platform 126 by separating the formed item from the mold 112, which separation may occur when the mold 112 is on the mold platform 126, as the mold 112 is being removed from the mold platform 126, or after the mold 112 has been removed from the mold platform 126. After the mold 112 and the formed item are removed from the mold platform 126, the process ends at block 226.

A person of skill in the art will recognize that the process 200 can include more or fewer steps than those specifically outlined above. A person of skill in the art will further recognize that the steps of the process 200 can be executed in the above outlined order, or in any other desired order, and the process 200 is not limited to the above outlined steps.

A person skilled in the art will further recognize that each of the components and features can be inter-connected and controllably connected using a variety of techniques and hardware and that the present disclosure is not limited to any specific method of connection or connection hardware.

The technology is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, programmable consumer electronics, network PCs, minicomputers, mainframe computers, distributed computing environments that include any of the above systems or devices, and the like.

As used herein, instructions refer to computer-implemented steps for processing information in the system. Instructions can be implemented in software, firmware or hardware and include any type of programmed step undertaken by components of the system.

A microprocessor may be any conventional general purpose single- or multi-chip microprocessor such as a Pentium® processor, a Pentium® Pro processor, a 8051 processor, a MIPS® processor, a Power PC® processor, or an Alpha® processor. In addition, the microprocessor may be any conventional special purpose microprocessor such as a digital signal processor or a graphics processor. The microprocessor typically has conventional address lines, conventional data lines, and one or more conventional control lines.

The system may be used in connection with various operating systems such as Linux®, UNIX® or Microsoft Windows®.

The system control may be written in any conventional programming language such as C, C++, BASIC, Pascal, or Java, and ran under a conventional operating system. C, C++, BASIC, Pascal, Java, and FORTRAN are industry standard programming languages for which many commercial compilers can be used to create executable code. The system control may also be written using interpreted languages such as Perl, Python or Ruby.

The foregoing description details certain embodiments of the systems, devices, and methods disclosed herein. It will be appreciated, however, that no matter how detailed the foregoing appears in text, the systems, devices, and methods can be practiced in many ways. As is also stated above, it should be noted that the use of particular terminology when describing certain features or aspects of the invention should not be taken to imply that the terminology is being re-defined herein to be restricted to including any specific characteristics of the features or aspects of the technology with which that terminology is associated.

It will be appreciated by those skilled in the art that various modifications and changes may be made without departing from the scope of the described technology. Such modifications and changes are intended to fall within the scope of the embodiments. It will also be appreciated by those of skill in the art that parts included in one embodiment are interchangeable with other embodiments; one or more parts from a depicted embodiment can be included with other depicted embodiments in any combination. For example, any of the various components described herein and/or depicted in the Figures may be combined, interchanged or excluded from other embodiments.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

All references cited herein are incorporated herein by reference in their entirety. To the extent publications and patents or patent applications incorporated by reference contradict the disclosure contained in the specification, the specification is intended to supersede and/or take precedence over any such contradictory material.

The term “comprising” as used herein is synonymous with “including,” “containing,” or “characterized by,” and is inclusive or open-ended and does not exclude additional, unrecited elements or method steps.

All numbers expressing quantities of ingredients, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should be construed in light of the number of significant digits and ordinary rounding approaches.

The above description discloses several methods and materials of the present invention. This invention is susceptible to modifications in the methods and materials, as well as alterations in the fabrication methods and equipment. Such modifications will become apparent to those skilled in the art from a consideration of this disclosure or practice of the invention disclosed herein. Consequently, it is not intended that this invention be limited to the specific embodiments disclosed herein, but that it cover all modifications and alternatives coming within the true scope and spirit of the invention as embodied in the attached claims.

What is claimed is:

1. A dual action gyratory thermoforming press comprising:
a top platform;
a bottom platform, wherein the bottom platform is displaceable from a first position relatively distant from the top platform to a second position relatively proximate to the top platform;
a multiposition gyratory head rotationally connected to the bottom platform; the multiposition gyratory head comprising at least a first forming vessel and a second forming vessel; wherein the first forming vessel comprises a first mold platform; and
a cam configured to interact with the first mold platform to displace the first mold platform relative to the top platform.

2. The dual action gyratory thermoforming press recited in claim 1, wherein the second forming vessel comprises a second mold platform.

3. The dual action gyratory thermoforming press recited in claim 2, wherein the cam is configured to interact with the second mold platform to displace the second mold platform relative to the top platform.

4. The dual action gyratory thermoforming press recited in claim 1, wherein the multiposition gyratory head comprises a third forming vessel, a fourth forming vessel, and a fifth forming vessel.

5. The dual action gyratory thermoforming press recited in claim 4, wherein the third forming vessel, the fourth forming vessel, and the fifth forming vessel respectively comprise a third mold platform, a fourth mold platform, and a fifth mold platform.

6. The dual action gyratory thermoforming press recited in claim 5, wherein the cam is configured to interact with the third mold platform, the fourth mold platform and the fifth mold platform to displace the third mold platform, the fourth mold platform and the fifth mold platform relative to the top platform.

7. The dual action gyratory thermoforming press recited in claim 1, further comprising a drive connected to the multiposition gyratory head.

8. The dual action gyratory thermoforming press recited in claim 7, wherein the drive rotates the multiposition gyratory head.

9. A method of thermoforming an item comprising:
placing a mold in a forming vessel of a multiposition gyratory head;
rotating the forming vessel of the multiposition gyratory head into alignment with mating features of a top platform;
displacing the gyratory head towards the top platform; and
rotating the forming vessel of the multiposition gyratory head out of alignment with mating features of the top platform.

10. The method recited in claim 9, further comprising aligning a sheet with the mating features of the top platform.

11. The method recited in claim 9, wherein the mold is placed on a mold platform in the forming vessel.

12. The method recited in claim 11, wherein the mold platform is displaced towards the mating features of the top platform.

13. The method recited in claim 11, wherein the forming vessel of the multiposition gyratory head mates with the mating features of the top platform when the multiposition gyratory head is displaced towards the top platform.

14. The method recited in claim 9, wherein the top platform is displaced towards the gyratory head.

15. The method of claim 9, wherein the mold is removed from the forming vessel.

16. The method of claim 9, wherein the item is separated from the mold.

17. The method of claim 9, wherein the item is an orthodontic insert.

18. A method of forming an orthodontic insert comprising:
preparing mold corresponding to a tooth of a patient;
placing the mold in a forming vessel of a multiposition gyratory head;
rotating the forming vessel of the multiposition gyratory head into alignment with mating features of a top platform;
displacing the gyratory head towards the top platform;
forming the orthodontic insert on the mold;
rotating the forming vessel of the multiposition gyratory head out of alignment with mating features of the top platform; and
separating the mold and the formed orthodontic insert.

19. The method of forming an orthodontic insert according to claim 18, further comprising placing a second mold in a second forming vessel of a multiposition gyratory head.

20. The method of claim 19, further comprising rotating the second forming vessel of the multiposition gyratory head into alignment with mating features of the top platform.

21. The method of claim 20, further comprising forming a second orthodontic insert on the second mold.
